(19) United States
(12) Patent Application Publication
(10) Pub. No.: US 2011/0191247 A1
(43) Pub. Date: Aug. 4, 2011

(54) AUTHENTICATION FRAMEWORK EXTENSION TO VERIFY IDENTIFICATION INFORMATION

(76) Inventors: Ben Dominguez, San Bruno, CA (US); Jagdeep Sahota, Rodeo, CA (US); Thanigaivel Ashwin Raj, Foster City, CA (US)

(21) Appl. No.: 13/014,584

(22) Filed: Jan. 26, 2011

Related U.S. Application Data
(60) Provisional application No. 61/299,912, filed on Jan. 29, 2010.

(51) Int. Cl. G06Q 40/00; G06Q 99/00

(52) U.S. Cl. 705/64; 705/44; 705/317

(57) ABSTRACT

Systems and methods for authenticating parties involved in a transaction are disclosed. Some embodiments of the disclosure are directed to systems and methods for authenticating various identification attributes of a participant in a transaction. The attributes can include items such as the participant's name, address, social security number, date of birth, or any other identifying attributes. In some embodiments, all participants in a transaction may have identification information authenticated. The 3-D Secure protocol and framework is extended and enhanced to provide the ability to authenticate the identification details of participants in transactions.

### CROSS REFERENCES TO RELATED APPLICATIONS

This application is a non-provisional of and claims the benefit of U.S. patent application Ser. No. 61/299,912 filed on Jan. 29, 2010, entitled “AUTHENTICATION FRAMEWORK EXTENSION TO VERIFY IDENTIFICATION INFORMATION” the contents of which is herein incorporated by reference in its entirety for all purposes.

### BACKGROUND

Electronic commerce accounts are frequently used by consumers to make purchases or engage in other transactions. Electronic commerce accounts include credit cards, debit cards, prepaid purchase cards, travel cards, or any other accounts that can be used to purchase goods or services or engage in other types of transactions. The ever increasing reliance on electronic commerce accounts, which can also be referred to as transaction accounts, has resulted in the need to ensure the security and reliability of transactions conducted with such accounts.

The 3-D Secure authentication protocol and framework is one such system to increase the security of transactions conducted online. In a typical transaction utilizing the 3-D Secure protocol, a consumer may desire to purchase a good or service from a merchant. The merchant, using a merchant plug-in, which is a computer program running on the merchant's transaction processing system, identifies the issuer of the consumer's transaction account. Typically, the consumer will provide an account number associated with the transaction account and the merchant plug-in will query a directory server which can determine the issuer associated with the account number. The issuer is typically a bank where the consumer maintains an account, although other types of issuers are possible.

The directory server may then query an authorization control server associated with the issuer to determine if the consumer has enrolled for the authentication service. In some cases, if the consumer is not already enrolled, the consumer is given the opportunity to enroll. If the consumer enrolls or is already enrolled, the directory server may return a response indicating that the consumer is capable of being authenticated. The merchant plug-in may then redirect the consumer to a site, such as a website, that is associated with the issuer's authorization control server. Once redirected, the authorization control server may prompt the consumer to enter a password that has been previously established between the issuer and the consumer.

If the password entered by the consumer matches that stored by the issuer, the consumer can be said to have been authenticated. Only the legitimate owner of the transaction account should be able to provide the proper password. The issuer system may then return a response to the merchant plug-in indicating that the consumer has been authenticated. The transaction may then proceed, and the consumer is able to complete the purchase of goods or services.

The existing 3-D Secure protocol and framework provides a secure and reliable system for authenticating transaction account holders when they are engaged in purchase transactions. However, transaction accounts are frequently being used for other types of transactions that are not direct purchase transactions. Furthermore, these types of transactions may have authentication needs that are different from just authenticating a consumer who is engaging in a transaction. It would be desirable to enhance and extend the existing 3-D Secure protocol and framework to extend the capabilities beyond simple password authentication of the holder of a transaction account.

Embodiments of this disclosure address these and other problems individually and collectively.

### BRIEF SUMMARY

Systems and methods for authenticating parties involved in a transaction are disclosed. Some embodiments of the disclosure are directed to systems and methods for authenticating various identification attributes of a participant in a transaction. The attributes can include items such as the participant's name, address, social security number, date of birth, or any other identifying attributes. In some embodiments, all participants in a transaction may have identification information authenticated. The 3-D Secure protocol and framework is extended and enhanced to provide the ability to authenticate the identification details of participants in transactions.

In one embodiment, a non-transitory computer readable medium is provided. The non-transitory computer readable medium may store thereon a set of instructions which when executed by a processor cause the processor to: send an authorization request to an authentication control server, the authorization request including data associated with a participant in a transaction; receive an authorization response from the authentication control server, the authorization response including an indicator that indicates portions of the data associated with the participant in the transaction that are verified; determine if the indicator meets or exceeds a threshold; and authorize the transaction if the threshold is met or exceeded.

In another embodiment, a non-transitory computer readable medium is provided. The non-transitory computer readable medium may store thereon a set of instructions which when executed by a processor cause the processor to: receive an authorization request, the authorization request including data associated with a participant in a transaction; compare the data associated with the participant in the transaction with data stored by an issuer; and send an authorization response, the authorization response including an indicator that indicates results of the comparison.

These and other embodiments of the invention are described in detail below.

### BRIEF DESCRIPTION OF THE DRAWINGS

FIG. 1 depicts an exemplary money transfer transaction.

FIG. 2 depicts exemplary an exemplary screen shot of a transfer transaction.

FIG. 3 depicts recipient authentication.

FIG. 4 depicts recipient authentication using encoded values.

FIG. 5 depicts a high level flow diagram of recipient authentication.

FIG. 6 depicts a high level flow diagram of authenticating a participant in a transaction.

FIG. 7 depicts a high level flow diagram of authenticating a participant in a transaction.

FIG. 8 depicts a high level diagram of a computer.

### DETAILED DESCRIPTION

The use of transaction accounts, such as debit and credit accounts, to pay for goods and services has become ubiquitous. It is becoming increasingly rare to find merchants or vendors that do not accept credit or debit cards for payment. In the world of e-commerce it is almost a requirement that payment be made using a debit or credit card account, as more traditional forms of payment, such as cash and checks, are generally inefficient or impossible to use online.

The use of credit or debit transaction accounts, which can also be simply referred to as accounts, for paying for goods or services provided by a merchant is well established. Typically, an account holder purchasing goods or services will present an account identifier, such as a plastic credit card, a smartcard, or even the account number itself, to a merchant. The merchant requests authorization from the issuer of the account to determine if sufficient funds or credit are available to make the purchase. If sufficient funds are available, the transaction is authorized, and the purchase is completed. Periodically, typically at the end of each business day, the merchant submits all authorized transactions to an acquiring bank for settlement. The acquiring bank then requests funds from the issuers of the authorized transactions. The issuers transfer funds to the acquiring bank, and those funds are then credited to the merchant's account.

In order to reduce the likelihood of fraudulent transactions, frameworks such as 3-D Secure, also referred to as Verified by Visa (VbV), have been developed. In the 3-D secure protocol, prior to a merchant requesting authorization for a transaction, communication is established between the purchaser and the issuer of the purchaser's account. The issuer may request an authentication of the purchaser, for example by requesting a password. If the password is correct, the purchaser is authenticated as an authorized user, and the authorization and settlement process above may be conducted.

In the above scenario, it is generally not necessary to perform any type of authorization or authentication of the merchant. The merchant typically has already established an authenticated relationship with his acquiring bank, which in turn will also have established relationships within the financial system. The processing of transactions between issuing banks and acquiring banks is well established, with processes and procedures in place for authenticating both issuer and acquiring banks.

The next stage in the evolution of the financial system may be to allow account holders to send payments to other account holders directly. Instead of an issuer transferring funds to an account held at an acquiring bank, the funds may simply be transferred directly to a transaction account that is associated with the recipient. Put another way, transfers between individuals or persons who do not have a relationship with an acquiring bank are envisioned. For example, a sender may wish to use his credit card account to send a payment to a receiver's credit card account. The payment will be credited directly to the receiver's credit card account, without requiring the use of an acquiring bank.

One such direct account to account payment service that has been contemplated is a Money Transfer (MT) service. The MT service may allow a sender to send money to a recipient using his credit or debit card. The sender may log in to a MT website or visit a physical location which has a kiosk for performing money transfers. The sender may provide his account details, such as a credit card number, by typing the numbers into a website or swiping his card. The sender may then enter the account number of the intended recipient. Funds can then be transferred directly from the sender's account to the recipient's account, bypassing the need for an acquiring bank.

Such a service would be a great convenience for transferring money between individuals directly using their respective accounts. However, there are additional concerns raised from a security and account issuer perspective. For example, if the transfer only requires the sender's account number and the recipient's account number, there is no way to authenticate the name of the person who is receiving the funds. In many countries, for purposes of security, it is required that the name and potentially other identifying information of an individual receiving funds be known. This name needs to be authenticated by the issuer of the recipient's account. For example, in the United States, certain individuals may be on the Specially Designated National (SDN) list. US Citizens are prohibited from doing any type of business, including transferring money, with anyone who is on the SDN list. It would be necessary for the MT service to be able to authenticate a recipient's name with the issuer of the recipient's account.

The authentication of a recipient's name prevents a sender from entering an account number for a recipient on an SDN list, but then entering a fake recipient name. The above SDN list is exemplary and is not limiting. There can be any number of reasons why the recipient's name needs to be authenticated. Furthermore, the authentication may extend past the recipient's name to also include a date of birth, social security number, address, or any other identifying details that can be authenticated by the recipient's issuer.

Additionally, authentication of identification details is not limited to recipients only. The sender's information can be authenticated as well. Furthermore, the types of transactions are not limited to money transfer transactions. Any transaction in which identification details of one or more participants in the transaction needs to be authenticated has been contemplated.

Embodiments of the disclosure provide the ability to verify consumer information versus information the issuer owns and which was provided to the issuer when the account was established. Embodiments extend the 3-D Secure authentication framework functionality to transport new data elements that the issuer can then evaluate against the issuer's data. Cardholder name verification has been identified as one such data element that requires authentication in a money transfer transaction. Additionally, compliance requirements may require that originators of money transfer transactions be able to verify that the recipient name provided by the sender of the transaction matches the name on the receiving account.

In a money transfer transaction, embodiments of the disclosure will enable a funding originator to send a query to a prospective recipient issuer in the form of a Payer Authentication request asking the recipient's issuer to verify that the cardholder name in their records matches the name provided in the request.

Embodiments of the disclosure extend the 3-D Secure authentication protocol and framework to include authentication of identification details. The current framework, as described above, is used for authentication of a consumer as part of a payment transaction. The consumer's account issuer is identified, and the consumer is prompted by the issuer to enter a password. If the password matches what the issuer has stored, then the transaction is allowed to proceed. The framework may be extended to allow for verification of other details of participants in a transaction. For example, a recipient's identification information can be authenticated, even though funds are not being withdrawn from the recipient's account. Furthermore, for additional security, the sender's identification information, may also be verified.

Exemplary Systems

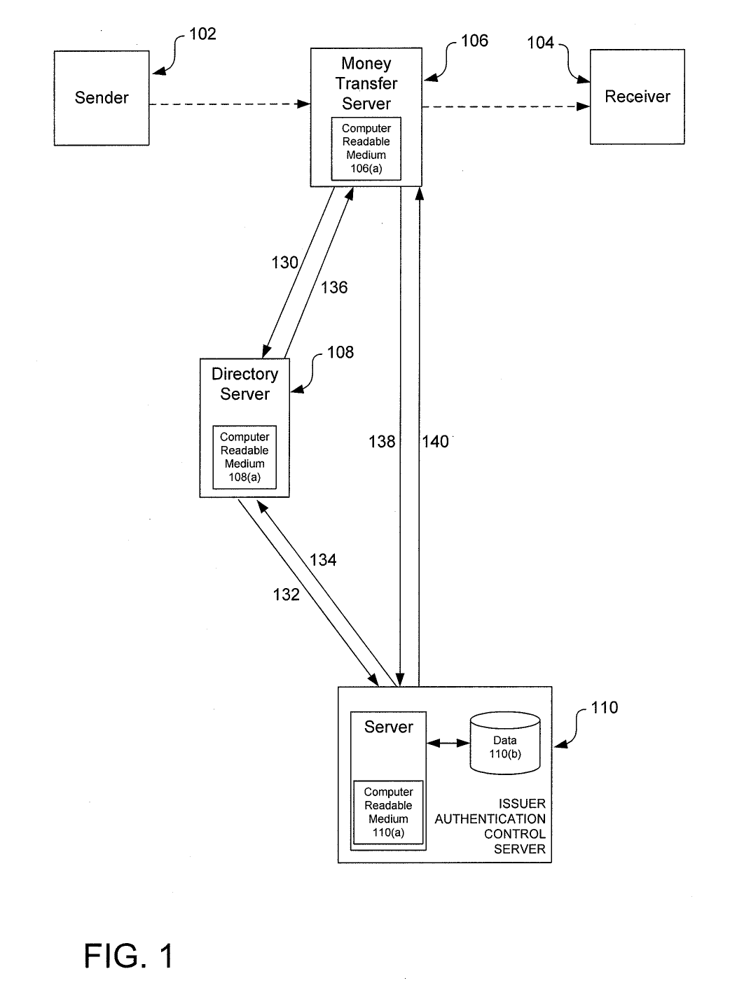

FIG. 1 depicts an exemplary money transfer transaction. As mentioned above, a money transfer transaction is one type of transaction that may benefit from embodiments of the disclosure. However, it should be understood that embodiments of the disclosure are not limited to money transfer transactions, and the description of money transfer transactions is for purposes of explanation, and not limitation.

A sender 102 may wish to transfer funds from his account to an account of a receiver 104. The sender and the receiver can also be referred to as participants in the transaction. The receiver's account may have been provided by an issuer 110. The sender's account may also be provided by an issuer (not shown). For purposes of simplicity of explanation, the money transfer transaction is described relative to the receiver. However, it should be understood that the authentication of identification details performed with respect to the receiver can also be performed with respect to the sender.

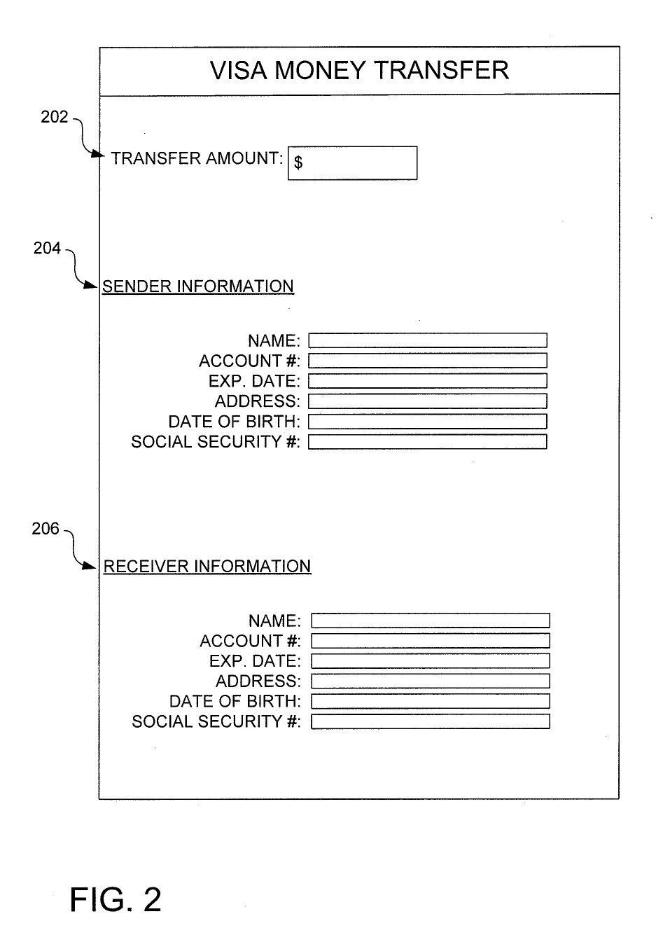

In order to engage in the money transfer, the sender 102 accesses a Money Transfer Server 106. The Money Transfer Server may include a computer readable medium 106(a) which contains computer code that when executed by the Money Transfer Server 106 causes the server to execute the steps described herein. The method of access can be in any suitable form. For example, sender 102 may access a web site provided by money transfer server 106. Alternatively, sender 102 may visit a physical location containing a kiosk operatively connected to the money transfer server 106. The sender 102 may provide the Money Transfer Server 106 with details of the transaction such as account to transfer from and to, and the amount. In addition, identifying information for the recipient and possibly the sender are also provided. An exemplary input screen is shown in FIG. 2.

Upon receiving the transaction information from the sender 102, the Money Transfer Server 106 may send a Verifying Enrollment Request (VEReq) 130 to a directory server 108. The directory server 108 may also contain a computer readable medium which contains computer code that when executed by the directory server 108 causes the server to execute the steps described herein. Based on transaction details, generally the account number of the recipient's account, the directory server 108 can determine the issuer of the recipient's account. For example, the first six digits of a transaction account typically determine the bank that issued the account. In some cases, the directory server 108 itself is able to determine that the recipient's issuer is unable to authenticate identification information. In such cases, the directory server 108 simply sends a Verifying Enrollment Response (VEResp) 136 that indicates that the issuer is not capable of verifying recipient identification information. This does not mean the recipient is not authentic, but rather the issuer cannot or chooses not to implement the authentication system.

In most cases, the directory server 108 will be able to identify an Authentication Control Server (ACS) 110 that is associated with the issuer of the recipient's account. The ACS 110 may also be referred to as an Access Control Server or Authorization Control Server. The ACS 110 may also contain a computer readable medium which contains computer code that when executed by the ACS 110 causes the server to execute the steps described herein. The directory server 108 forwards the VEReq 132 to the ACS 110. As depicted in FIG. 1, the ACS is shown as integrated within the account issuer's system. However, this configuration is for purposes of explanation and not limitation. In some cases, the issuer's ACS may reside external to the issuer's systems. In other cases, the ACS may be provided by a third party that provides ACS services for multiple issuers. What should be understood is that issuers who have implemented embodiments of the disclosure will provide an ACS 110 that is configured to provide the functionality described below.

Upon receipt of a VEReq message from a directory server 108, the ACS 110 can then determine if the particular recipient account number is able to be authenticated. This step does not authenticate the recipient, but rather determines that the ACS is capable of authenticating the recipient. The ACS 110 then sends a VEResp 134 to the directory server 108. The directory server 108 forwards the VEResp 136 to the money transfer server 106. If the recipient can be authenticated, the VEResp will include contact information, such as an IP address, for the ACS 110 that can authenticate the recipient.

The Money Transfer Server 106 then analyzes the VEResp 136 to determine if the recipient can be authenticated. If not, the Money Transfer Server 106 may either allow or deny the transaction based on business or regulatory rules. For example, if there is a requirement, business or legal, that the recipient must be authenticated prior to a money transfer, then the Money Transfer Server 106 would deny the transaction. If authenticating a recipient is optional, then the Money Transfer Server 106 could proceed with the transaction.

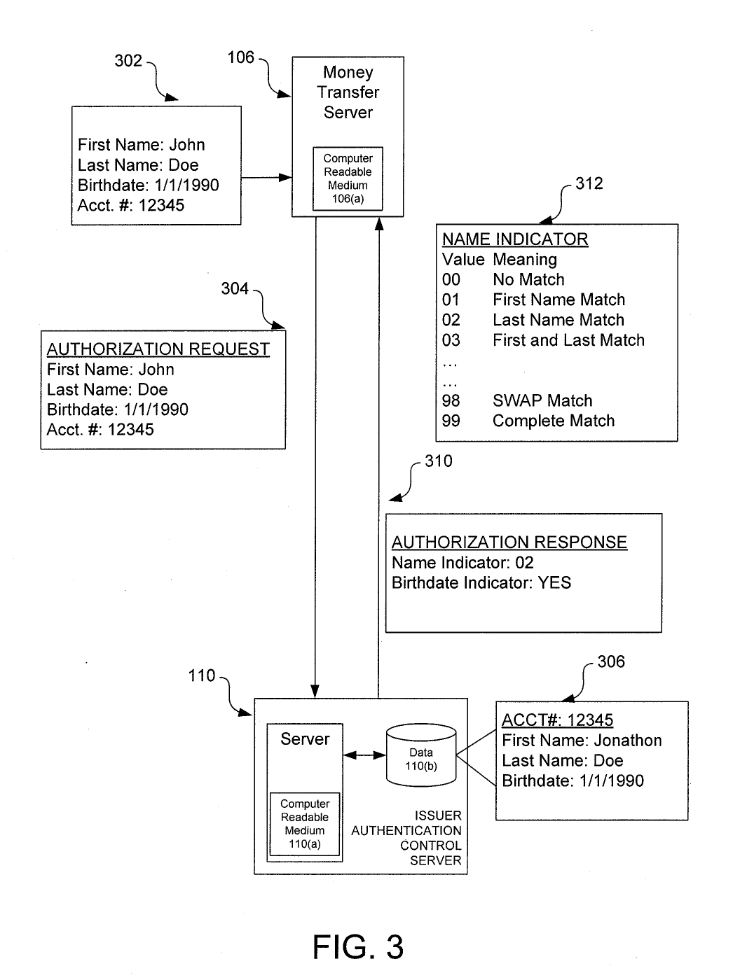

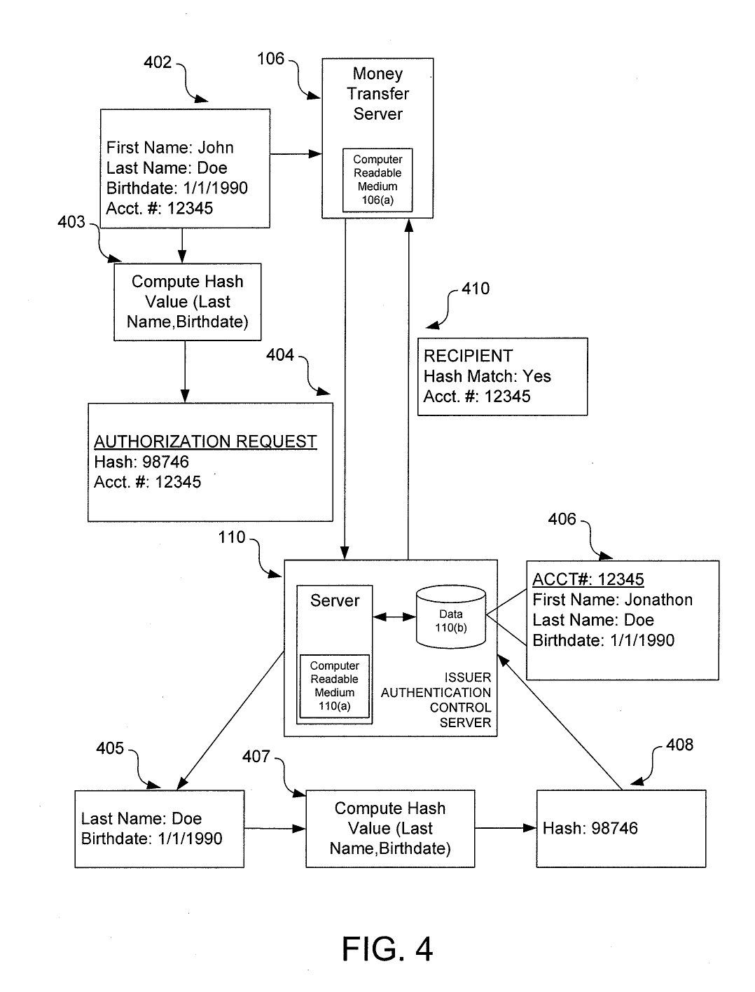

If the VEResp 136 indicates the recipient can be authenticated, the Money Transfer Server 106 can send a Payer Authorization Request (PAReq) 138 to the ACS 110 that was identified in the VEResp 136. The term Payer Authorization Request should not be interpreted as implying the request is associated with a payment. Rather, the PAReq is a request type that is defined in the 3-D Secure protocol. Embodiments of the instant disclosure extend the functionality provided by the existing 3-D Secure protocol. The PAReq 138 may include the recipient's account number, and any number of identifying details about the recipient. Some example details are shown in FIG. 2. In some embodiments, the PAReq 138 will not include identification details, but rather encoded versions of the identification details. In yet other embodiments, the PAReq may include no identification details other than the recipient's account number. The contents of the PAReq will be described in further detail with respect to FIGS. 3 and 4.

The ACS 110 may then retrieve information about the recipient from a database 110(b) maintained by the issuer by using the account number. Because the issuer is the entity that issued the account, the issuer will have identification data about the recipient, as this information would have been required to initially establish the account. Assuming that the issuer properly verified the recipient's information upon establishing the account, the recipient data stored in the database 110(b) should be authentic. For example, when establishing an account, the issuer may require the presentation of credentials, such as a passport or driver's license, to ensure that the person establishing the account is providing legitimate information.

The ACS 110 may then compare the identification information in the PAReq to data retrieved from the database 110(b). In some embodiments, the ACS will simply make a yes/no determination as to if the recipient has been authenticated. In other embodiments, the authentication may be more granular. For example, if the ACS 110 is able to authenticate the name, but not a date of birth or social security number, the ACS can indicate that it was only able to authenticate portions of the recipient's identification information. Similarly, if the ACS 110 is able to authenticate the recipient's last name, but not the first name, the ACS 110 can indicate it was only able to authenticate a portion of the name. Additional embodiments will be described with respect to FIGS. 3 and 4.

Once the ACS 110 has made an authentication determination, this information can be returned to the Money Transfer Server 106 in a Payer Authorization Response (PAResp) 140 message. Again, the term Payer Authorization Response should not be interpreted to imply that a payment transaction is being conducted. Rather, the PAResp 140 message is an existing message within the 3-D Secure protocol and embodiments of the present disclosure modify the existing protocol to provide functionality that did not previously exist.

The Money Transfer Server 106 may receive the PAResp 140 message, and determine if the transaction should proceed. Just as above, the Money Transfer Server 106 can allow or deny the transaction based on the level of authentication. For example, if the ACS 110 simply returns a yes/no value for authentication, laws and rules may require that the transaction be denied if a no is returned. In the alternative, the laws or rules may specify that if a no is received for authentication from the issuer, the transaction may proceed, but the operator of the money transfer server 106 will then assume liability for any consequences of allowing an unauthenticated recipient. This flexibility is also available if the ACS responds with an indication that only portions of the recipient's identification could be authenticated. For example, if the ACS 110 is able to authenticate the last name but not the first name, or was able to authenticate the name but not the social security number, the Money Transfer Server 106 could then make a decision to either allow or deny the transaction.

Although the above description has been in terms of authenticating the recipient, it should be understood that the exact same framework could be used to authenticate the sender. For example, a fraudulent sender may have stolen a credit card and thus has access to the account number, and typically the name of the account holder, as embossed on the front of the card. However, if identification details of the sender, such as social security number or date of birth are required, a fraudulent sender would not be able to use the stolen card to transfer funds because the fraudulent user would not be in possession of those pieces of information.

FIG. 2 depicts exemplary an exemplary screen shot of a transfer transaction. The sender may specify an amount 202 that he wishes to transfer. The sender may also specify identification information 204 about the sender. As explained above, this information can be useful in preventing unauthorized senders from transferring funds. Sender information 204 can include information such as the name, account number, expiration date of the account, address, date of birth, and social security number. As should be clear, the identification details are simply examples, and any other identifying information could be used as well. There is also no requirement that all of the exemplary pieces of information be present. Receiver information 206 can be similar to sender information, with some exemplary pieces of identification information shown. Again, there could be more, less, or different identification elements used. Furthermore, there is no requirement that sender and receiver use the same pieces of identification information. For example, a sender may need to specify his name and date of birth, while only the recipient's name is necessary.

Furthermore, the exemplary screen shot depicted in FIG. 2 is not intended to limit embodiments of the disclosure to money transfer transactions. Rather, FIG. 2 depicts one type of transaction in which embodiments of the invention can advantageously be used to provide improved authentication of transaction participant identification information while advantageously reusing the 3-D Secure protocol and framework. Any type of transaction in which authentication of participant identification details would be beneficial has been contemplated.

Exemplary Methods

FIG. 3 depicts recipient authentication. A sender (not shown) may provide identification details 302 of a recipient. For example, the sender could provide such information on a webpage provided by a money transfer server 106 as depicted in FIG. 2. In this example, the recipient information 302 includes the recipient's first and last name, his birthdate, and his account number. The money transfer server 106 may determine if the recipient can be authenticated by sending a VEReq and receiving a VEResp as described above with respect to FIG. 1. If the recipient's identification information can be authenticated by the recipient's issuer, the process may proceed.

The money transfer server, or more specifically a plug-in installed on the money transfer server, may then send a PAReq 304 message to the ACS 110 that is associated with the recipient's issuer. As shown, the PAReq 304, which can more simply be referred to as an authorization request, may include the identification details of the recipient that are to be authenticated. In the present example, the information includes the recipient's first and last name, birthdate, and account number.

The ACS 110 may then receive the PAReq 404. Using the account number contained therein, the ACS my query a database 110(b) associated with the issuer to retrieve the identification details provided by the recipient when the account was established. As mentioned above, it is to be assumed that the issuer verified the recipient's identification information when the account was established. The ACS may then compare the identification details in the PAReq 304 message with the retrieved details 306 to determine if there is a match.

In some embodiments, the ACS 110 may make the final determination of if the identification details are authenticated. For example, the ACS 110 may simply return a value in an indicator in the PAResp message that indicates that the identification details match or do not match. Thus, the ACS 110 is the final arbiter of the authentication of the recipients identification information. The ACS 110 may use policies defined by the issuer to determine to what level the identification details must match before the details are considered authentic. For example, as shown in FIG. 3, the PAReq 304 message includes the recipient's first name as John, whereas the stored identification details 306 indicate that the recipient's actual first name is Jonathon. It can then be left to the policies of the issuer to determine if such an error in identification details is sufficient to indicate that the details in the PAReq message could not be authenticated. Thus, in such an embodiment, the issuer is given flexibility in determining if identification details are sufficiently authenticated.

In alternate embodiments, the ACS 110 may not make a yes/no decision with respect to the authentication results. For example, for each piece of identification information, the ACS 110 may respond with a match/no match indication. For example, the PAResp 310 message may include the exact information provided that was able to be authenticated. In the example as shown in FIG. 3, the PAReq 304 message indicates that the recipient's first name is John, while the issuer records indicate that the recipient's first name is Jonathon. This result could be communicated back to the money transfer server 106 in the form of a name indicator. The name indicator may include a value that can be interpreted to indicate to what degree the name matches. For example, name indicator table 312 shows some possible values for the name indicator. The name could have no match, a first name match, a last name match, first and last name match, or a complete match. In some cases, additional indicators could be provided for common errors, such as a swap match, in which the first and last names are reversed. Any number of such combinations could be included in the name indicator.

Furthermore, in some embodiments an indicator can also be provided for every other piece of identification information that is to be authenticated. As depicted in FIG. 3, the PAResp 310 message includes a birthdate indicator which indicates if the birthdate in the PAReq 304 message matches that which is in the database 306. It would be clear to a person of skill in the art that any number of such indicators could be provided. In some embodiments, a separate indicator is provided for each detail to be authenticated, while in yet other embodiments, aggregated indicators, such as the one described for the name above, may be provided. What should be understood is that the PAResp 310 message may include indicators that allow the money transfer server to determine to what extent the identification details of the recipient have been authenticated. Using those indicators, the money transfer server may determine if a transaction should be allowed to proceed.

FIG. 4 depicts recipient authentication using encoded values. In some cases, it may not be desirable to send sensitive information, such as a social security number, between a money transfer server 106 and the issuer 110. The network, such as the internet, used to transfer the information may be insecure. In order to overcome this potential problem, rather than send the actual identification information, encoded versions of the information might be sent. Ideally, the original information should not be recoverable from the encoded version.

Continuing with the example presented in FIG. 3, an exemplary recipient 402 might be John Doe, born on Jan. 1, 1990, who has an account number of 12345. It may not be desirable to send John Doe's actual name between the money transfer server 106 and the issuer 110. The money transfer server may instead convert the name to an encoded value. In one embodiment, this conversion may be in the form of a hash algorithm, such as SHA-1. A hash algorithm typically produces a hash value that is a fixed length. With a properly designed hash algorithm, the original data used to calculate the hash value cannot be recovered from the hash value. The creation of such hash algorithms is known in the art. Furthermore, the hash value need not correspond to a single data element. For example, a hash algorithm could take as an input a last name and a birthdate, and produce a hash value. Any combination of elements, such as the elements depicted in FIG. 2, could be used to generate a hash value.

As shown in FIG. 4, a hash value may be computed 403 by the money transfer server. This hash value and the corresponding account number can then be sent in a PAReq 404 message to the issuer 110. The issuer then may use the account number to retrieve identification information 406 for the account holder from the issuer's database 110(b). The information would typically include the account holder's name and any other information 405 used to calculate the hash value. The issuer 110 can then perform the same hash algorithm (e.g. SHA-1) 407 on the data retrieved 405 from the database. If the hash value generated 408 equals the hash value received 404, it can safely be assured that the name and birthdate entered at the money transfer server is the same as that stored in the issuer's database. This is because the likelihood of different pieces of data, such as names and birthdates, hashing to the same value is incredibly small with a properly designed hash algorithm. Thus if the same hash value is generated, this means that the same input, in this case a name and birthdate, was used. As such, the name and birthdate can be authenticated without having to actually transmit the name or birthdate from the Money Transfer Server 106 to the issuer 110.

The ACS 110 may then compare the hash value received in the PAReq 404 message and determine if it matches the value computed 408 by the ACS. If the values match, the ACS may return a PAResp 410 that indicates the hash values match. The Money Transfer Server 106 may interpret a match in the hash values as indicating that the identification details of the recipient have been authenticated.

In a slightly different embodiment as described with respect to FIG. 4, the money transfer server 106 may not include the hash value itself if the PAReq 404 message. Rather, the money transfer server may only include the account number. The ACS 110 would then follow the same procedure in computing the hash value, but rather than returning a match/no match indicator, the ACS may return the actual computed hash value in the PAResp 410. The money transfer server may then compare the previously computed hash value with the value returned by the ACS. If the values match, the money transfer server can consider the recipient's information authenticated. The two embodiments described are very similar, with the main difference being which entity is given final authority in determining if the recipient's identification information is authentic. In the first embodiment, the ACS 110 make the determination, whereas in the second embodiment, the money transfer server is responsible.

As should be clear, the above explanation is merely exemplary. Any number of encoding schemes, other than SHA-1 have been contemplated. Furthermore, combinations of identification elements may be used. For example, the name and a social security number may be combined prior to hashing. The issuer would then perform the same procedure. Thus a hash value match would indicate that both the name and social security number has been authenticated. Embodiments of the disclosure that utilize authentication using encoded values advantageously allow the identification details of a participant in a transaction to be authenticated, without having to transmit those identification details across potentially insecure networks. Furthermore, because hash values may be of a fixed length, embodiments that utilize hash values may advantageously avoid the complexity involved when dealing with variable length data, such as names.

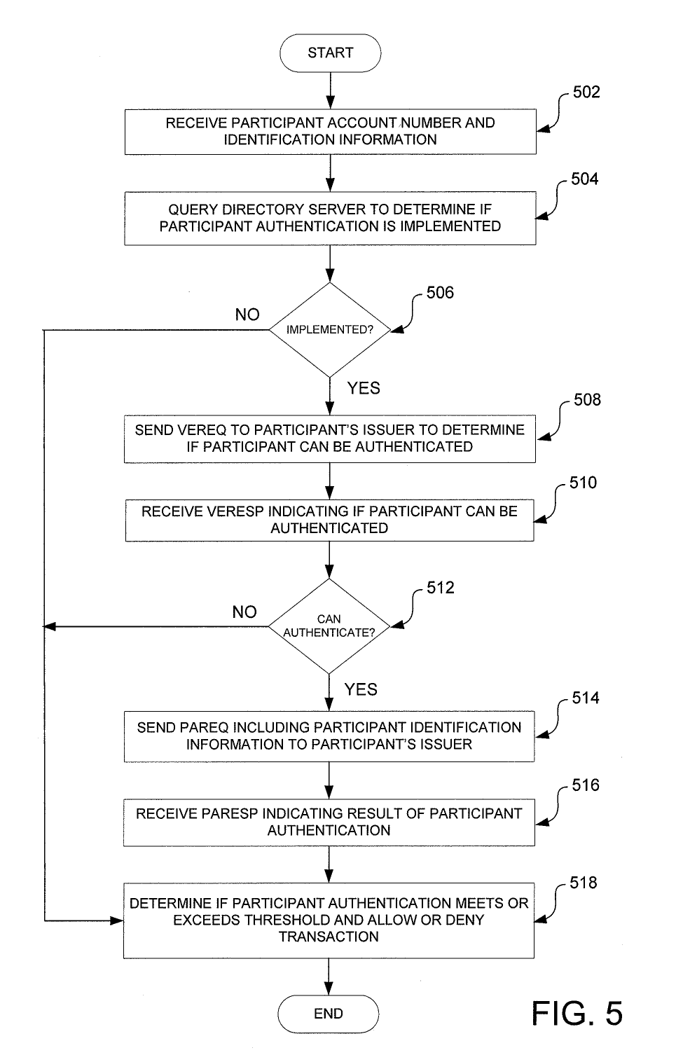

FIG. 5 depicts a high level flow diagram of transaction participant authentication. Just as above, FIG. 5 is described in terms of authenticating a recipient of a money transfer transaction, however this is for purposes of explanation. Embodiments of the disclosure advantageously allow for the authentication of identification information for any type of transaction where such information needs to be authenticated. The process may begin at step 502 wherein the recipient's account number and identification details may be received. At step 504, the directory server is queried with a VEReq message to determine if the issuer ACS is capable of authenticating the recipient. At step 506, if the issuer is not capable of authentication, the process moves to step 518, which will be described below. If the issuer ACS is able to authenticate recipient information, at step 508 the VEReq is sent to the issuer to determine if this specific recipient can be authenticated. The issuer responds with a VEResp that indicates if the specific recipient can be authenticated at step 510. At step 512, if the specific recipient cannot be authenticated, the process continues to step 518, described below.

At step 514, a PAReq message containing identification details of the recipient is sent to the issuer. At step 516, the PAResp from the issuer is received indicating the result of the authentication. As discussed above, the result could be a simple yes/no for authentication or an enumeration of what was authenticated and what was not, or an indication of a match of hash values, or a hash value itself. In all cases, the process arrives at step 518 where it is determined if the recipient has been sufficiently authenticated. What qualifies as sufficiently authenticated is flexible. A threshold may be established and if the authentication result in the PAResp message meets or exceeds the threshold, the recipient can be considered sufficiently authenticated.

For example, in cases where specific elements, such as a first and last name, are individually authenticated, the threshold could be set to indicate that a match on the last name alone is considered to be sufficient. Thus, a PAResp indicating a matched last name would be sufficient, even if there was no match on the first name. Setting the threshold can be very flexible, and can be adapted to the needs of the specific application. For example, cases where hash values are used, the threshold could be a simple yes/no as the hash value either matches or it does not. In cases where data elements are individually authenticated, the threshold could be set to indicate that a match of a certain number of elements is considered sufficient. For example, matching 3 of 5 elements, regardless of which elements, may be considered sufficient.

The recipient being sufficiently authenticated can then be used as an input to determine if the transaction should be allowed or denied. As was explained above, a transaction may still be allowed in some cases even if the recipient is not sufficiently authenticated. However, the responsibility for allowing such a transaction may shift the liability of a fraudulent transaction to the party that decided to allow the transaction, despite failure of the authentication process.

FIG. 5 has been presented in terms of recipient authentication, however it should be understood that the same process could be applied to a sender as well. Furthermore, the same process could also be applied to other types of transactions, and is not limited to transactions in which there is a sender and a receiver, or to transactions involving money transfer.

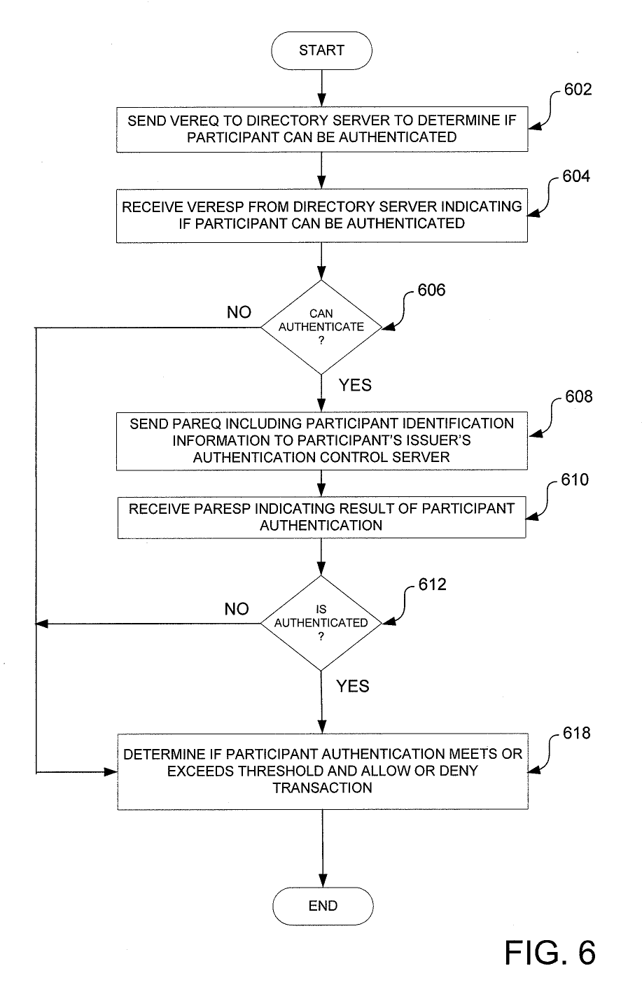

FIG. 6 depicts a high level flow diagram of authenticating a participant in a transaction. FIG. 6 is presented from the perspective of a transaction server, such as a money transfer server. The process may begin at step 602, wherein a VEReq message is sent to a directory server to determine if a participant in a transaction can have identification details authenticated. At step 604, a VEResp message may be received, the message including if the participant's identification details can be authenticated. At step 606, the results of the VEResp are analyzed. If the participant's identification details can not be authenticated, the process moves to step 618, which will be described below.

If the authentication details can be authenticated, the process moves to step 608, wherein a PAReq message, which includes participant identification information, is sent to the participant's issuer's authentication control server. As described above, the identification information can include data elements such as names or can include values such as hash values. The specific identification elements are flexible based upon the application. At step 610, a PAResp message is received from the issuer authentication control server which indicates the results of the authentication.

The process then moves to step 612, wherein the results of the PAResp are analyzed to determine if the participant has been authenticated. If the participant has not been authenticated, the process moves to step 618, which is described below. If the participant has been authenticated at some level, the process moves on to step 618. At step 618, it is determined if the level of authentication of the participant meets or exceeds a threshold, and based on this threshold, the transaction is allowed or denied. As described above, the threshold is flexible. In some cases, the threshold may be set such that if the participant can not be fully authenticated, the transaction is always denied. In other applications, the transaction may be allowed even if none of the participant identification details can be authenticated. In yet other cases, the threshold may be somewhere in between.

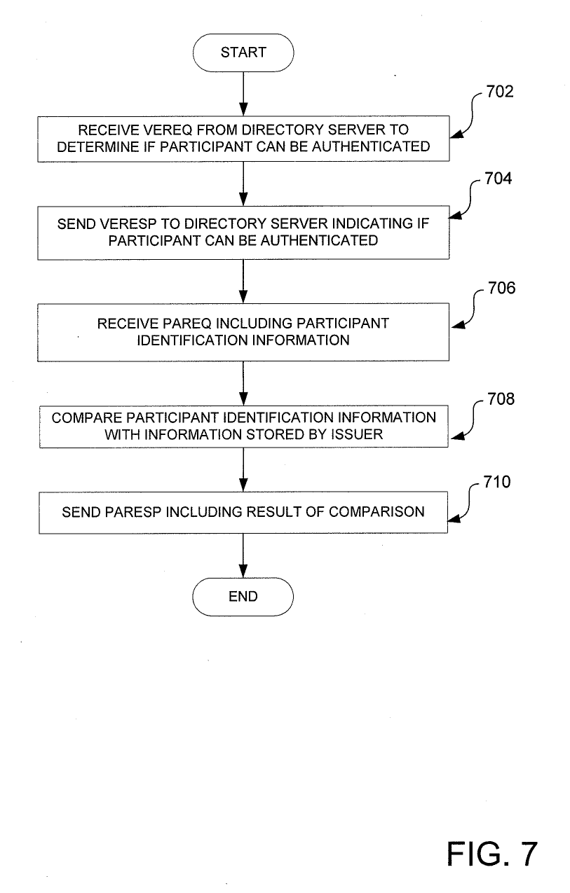

FIG. 7 depicts a high level flow diagram of authenticating a participant in a transaction. FIG. 7 is presented from the perspective of an issuer authentication control server. The process may begin at step 702, wherein a VEReq message is received from a directory server to determine if the ACS can authenticate a specific participant of a transaction. At step 704, a VEResp message may be returned, indicating if the participant can be authenticated.

If the participant can be authenticated, at step 706, a PAReq message which includes participant identification information may be received. At step 708, the received participant identification information can be compared with information stored by the issuer of the participant's account. As described above, this comparison can take different forms, from comparison of individual identification elements to comparison of hash values. At step 710, the results of the comparison can be returned.

Exemplary Operating Environment

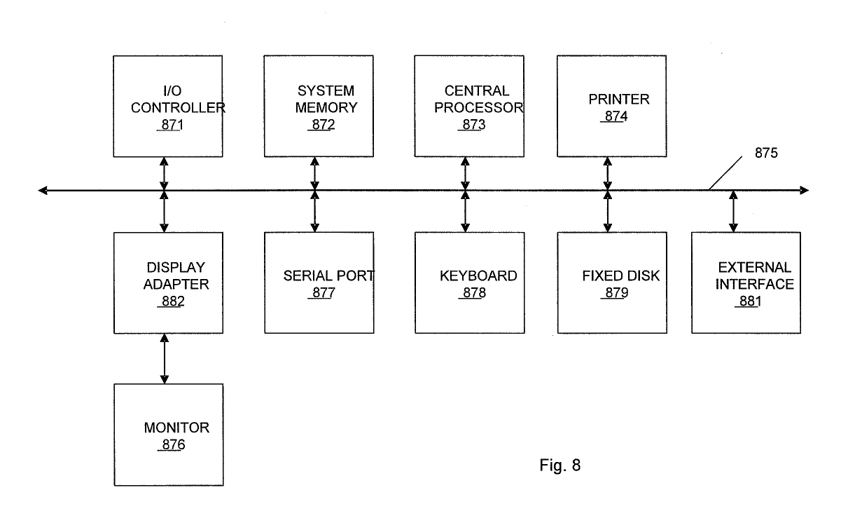

FIG. 8 depicts a high level diagram of a computer. The various participants and elements in the figures may operate or use one or more computer apparatuses to facilitate the functions described herein. Any of the elements in FIG. 1 (e.g., sender 102, receiver 104, directory server 108, ACS 110, etc.) may use any suitable number of subsystems to facilitate the functions described herein. Examples of such subsystems or components are shown in FIG. 8. The subsystems shown in FIG. 8 are interconnected via a system bus 875. Additional subsystems such as a printer 874, keyboard 878, fixed disk 879 (or other memory comprising computer readable media), monitor 876, which is coupled to display adapter 882, and others are shown. Peripherals and input/output (I/O) devices, which couple to I/O controller 871, can be connected to the computer system by any number of means known in the art, such as serial port 877. For example, serial port 877 or external interface 881 can be used to connect the computer apparatus to a wide area network such as the Internet, a mouse input device, or a scanner. The interconnection via system bus allows the central processor 873 to communicate with each subsystem and to control the execution of instructions from system memory 872 or the fixed disk 879, as well as the exchange of information between subsystems. The system memory 872 and/or the fixed disk 879 may embody a computer readable medium.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A non-transitory computer readable medium storing thereon a set of instructions which when executed by a processor cause the processor to:
send an authorization request to an authentication control server, the authorization request including data associated with a participant in a transaction;
receive an authorization response from the authentication control server, the authorization response including an indicator that indicates portions of the data associated with the participant in the transaction that are verified;
determine if the indicator meets or exceeds a threshold; and
authorize the transaction if the threshold is met or exceeded.

2. The non-transitory computer readable medium of claim 1, wherein the threshold is all of the data associated with the participant in the transaction.

3. The non-transitory computer readable medium of claim 1 further comprising instructions which cause the processor to:
send a verify enrollment request to a directory server, the verify enrollment request including information to identify the authentication control server that can verify the data associated with the participant in the transaction; and
receive a verify enrollment response from the directory server, the verify enrollment response indicating if the authentication control server is configured to verify data associated with the participant in the transaction.

4. The non-transitory computer readable medium of claim 1 further comprising instructions which cause the processor to:
compute a hash value based on data received from a user, and include the hash value as the data associated with the participant in the transaction.

5. The non-transitory computer readable medium of claim 1 wherein the participant in the transaction is a recipient of funds in a money transfer transaction.

6. The non-transitory computer readable medium of claim 1 wherein the participant in the transaction is a sender of funds in a money transfer transaction.

7. The non-transitory computer readable medium of claim 1 wherein the indicator that indicates portions of the data associated with the participant in the transaction that are verified is a yes/no indicator and the transaction is authorized when the indicator is set to yes.

8. A server computer comprising the non-transitory computer readable medium of claim 1.

9. A method comprising:
sending an authorization request to an authentication control server, the authorization request including data associated with a participant in a transaction;
receiving an authorization response from the authentication control server, the authorization response including an indicator that indicates portions of the data associated with the participant in the transaction that are verified;
determining, with a server computer, if the indicator meets or exceeds a threshold; and
authorizing the transaction if the indicator meets or exceeds the threshold.

10. The method of claim 9 further comprising:
computing, with the server computer, a hash value based on data received from a user, and including the hash value as the data associated with the participant in the transaction.

11. A non-transitory computer readable medium storing thereon a set of instructions which when executed by a processor cause the processor to:
receive an authorization request, the authorization request including data associated with a participant in a transaction;
compare the data associated with the participant in the transaction with data stored by an issuer; and
send an authorization response, the authorization response including an indicator that indicates results of the comparison.

12. The non-transitory computer readable medium of claim 11 wherein comparing the data associated with the participant in the transaction with data stored by an issuer further comprises instructions which cause the processor to:
calculate a hash value based on the data stored by the issuer; and
determine if the hash value is the same as the data associated with a participant in a transaction that was included in the authorization request.

13. The non-transitory computer readable medium of claim 11 wherein the indicator indicates one of no match, partial match, or complete match.

14. The non-transitory computer readable medium of claim 11 further comprising instructions which cause the processor to:
receive a verify enrollment request from a directory server, the verify enrollment request including information to identify an account associated with the participant in the transaction; and
send a verify enrollment response to the directory server, the verify enrollment response indicating if the processor is configured to verify data associated with the participant in the transaction.

15. The non-transitory computer readable medium of claim 11 wherein the participant in the transaction is a recipient of funds in a money transfer transaction.

16. The non-transitory computer readable medium of claim 11 wherein the participant in the transaction is a sender of funds in a money transfer transaction.

17. The non-transitory computer readable medium of claim 1 wherein the indicator that indicates portions of the data associated with the participant in the transaction that are verified is a yes/no indicator.

18. A server computer comprising the non-transitory computer readable medium of claim 11.

19. A method comprising:
receiving an authorization request, the authorization request including data associated with a participant in a transaction;
comparing the data associated with the participant in the transaction with data stored by an issuer; and
sending an authorization response, the authorization response including an indicator that indicates results of the comparison.

20. The method of claim 19 further comprising:
calculating a hash value based on the data stored by the issuer; and
determining if the hash value is the same as the data associated with a participant in a transaction that was included in the authorization request.
